(19) United States
(12) Patent Application Publication
(10) Pub. No.: US 2011/0287689 A1
(43) Pub. Date: Nov. 24, 2011

(54) AIR SOURCE FOR UNIVERSAL CONNECTION TO ANIMAL GRUNTS

(76) Inventor: Billy James Griffin, Rockville, IN (US)

(21) Appl. No.: 12/785,516

(22) Filed: May 24, 2010

(51) Int. Cl. A01M 31/00; A63H 5/00

(52) U.S. Cl. 446/193; 446/197

(57) ABSTRACT

An air emitter for universally connecting to a variety of animal grunts. A squeezable container encloses a one piece squeezable filling forming an air chamber into which a flexible sleeve extends. The sleeve opens outwardly of the container to releasably lock to the inlet tube of an animal grunt.

### BACKGROUND OF THE INVENTION

1. Field of the Invention

The present invention relates generally to the field of animal call devices and more specifically squeezable containers for forcing air into an animal grunt.

2. Description of the Prior Art

Animal grunts consist of an elongated tube in which is located a reed that will vibrate when air is forced through the grunt thereby mimicking an animal sound. Typically, the animal grunt is activated by the hunter or other person by blowing into the grunt. Since the hands of a hunter are already occupied by things, such as, a bow and arrow or a firearm, a variety of squeezable pouches have been devised that are connected to the grunts. The pouch can be squeezed by the arm of the hunter or even by stepping on the pouch thereby freeing the hunter's hands.

A large number of U.S. patents have been granted on the combination of animal grunts and pouches. U.S. Pat. No. 2,583,400 issued to Wade discloses a grunt having a collapsible hollow bulb formed of rubber. U.S. Pat. No. 5,704,154 issued to Galfidi, Jr. discloses an air bladder that is filled with a resistant polyester filament and used in conjunction with a game call, whereas U.S. Pat. No. 7,384,324 issued to Fullmer discloses a bladder filled with a combination of liquid and rubber or silicon that is used in conjunction with a toy. The Fullmer device also discloses a foam sponge material within the bladder. U.S. Pat. No. 6,042,447 issued to Thompson discloses a pouch attached to the grunt that is filled with a compressible fiber with an elastic memory. Likewise, U.S. Pat. No. 6,240,671 issued to Galfidi, Jr. discloses a pouch or bladder that is filled with a resilient polyester filament. Further, U.S. Pat. No. 5,613,891 issued to Lamo discloses a grunt having a pouch that can be stepped on and also has a strap for carrying the grunt and pouch. The pouch is filled with a loose synthetic fiber having the characteristic of automatically expanding after being compressed.

### SUMMARY OF THE INVENTION

One embodiment of the present invention is a portable squeezable device having a universal connection for connecting to animal grunts for emitting a stream of air into an animal grunt. The squeezable container has an internal cavity with an air opening leading to external of the container. A squeezable filling is located in the cavity and forms an air chamber adjacent the air opening. A sleeve is mounted to the squeezable container and extends through the air opening and into the air chamber. The sleeve has an inner end and an outer end with an internal passage extending therebetween. The internal passage has a decreasing tapered size as it extends inwardly from the outer end. The passage includes a plurality of inwardly extending projections to releasably hold the air inlet tube of the animal grunt.

It is an object of the present invention to provide a new and improved portable squeezable device for emitting a stream of air into an animal grunt for the grunt to emit an animal noise in response.

A further object of the present invention is to provide a portable squeezable device having a universal connection for connecting to a variety of different types of animal grunts for forcing air therein.

An additional object of the present invention is to provide a new and improved combination of an animal grunt and flexible container that are removably connected together.

Related objects of the present invention will be apparent from the following description.

### BRIEF DESCRIPTION OF THE DRAWINGS

FIG. 1 is an exploded perspective view of an animal grunt positioned to be inserted into the squeezable container.

FIG. 2 is an enlarged cross-sectional view taken along the line 2-2 of FIG. 1 and viewed in the direction of the arrows.

FIG. 3 is an enlarged cross-sectional view taken along the line 3-3 of FIG. 1 and viewed in the direction of the arrows.

FIG. 4 is an enlarged cross-sectional view of the sleeve also shown in FIG. 3.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

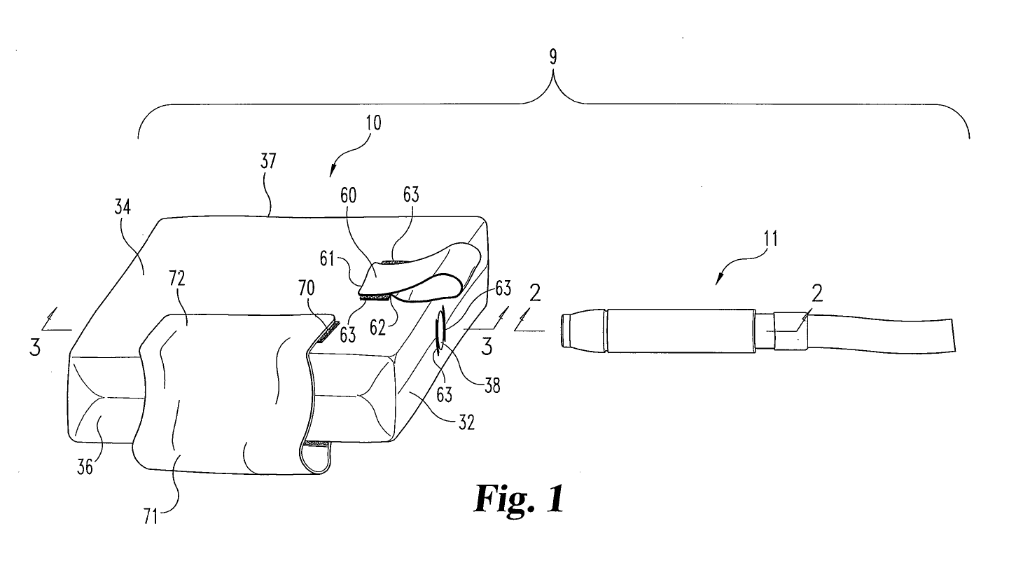

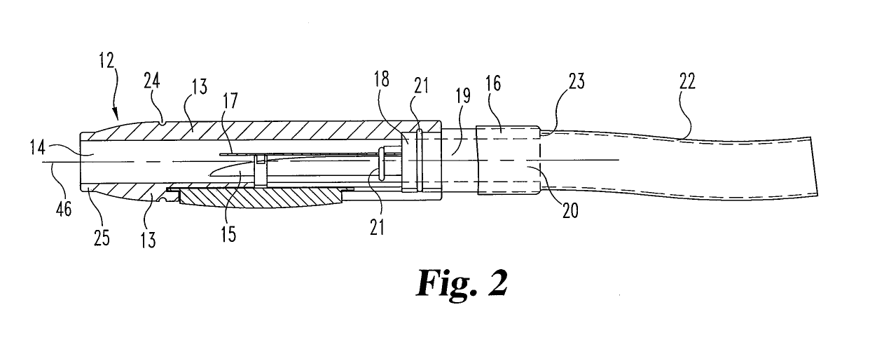

Now referring more particularly to FIG. 1, there is shown an exploded view of the combination 9 of squeezable container 10 for receiving a variety of different configured animal grunts 11. Grunts 11 are commercially available and come in a variety of different male ends 12 (FIG. 2). The grunt has a main body 13 with an air inlet 14 formed in end 12 of the main body. The air inlet leads through a passage to a cantileverly mounted member 15 secured to a second main body 16. A vibratory reed 17 is cantileverly mounted to end 18 of main body 16 with a passage 19 extending between member 15 and reed 17 and leading to the air outlet 20. Main body 16 is removably mounted to main body 13 by sliding end 18 into main body 13 with a conventional O-ring 21 provided between main bodies 13 and 16 to prevent air from escaping therebetween. A flexible rubber tube 22 is mounted to the end 23 of main body 16. By forcing air through inlet 14, reed 17 is caused to vibrate with the noise generated then passing through passage 19 and exiting outlet 20 via tube 22. A variety of animal grunts similar to grunt 11 are commercially available. For example, such calls are available from Hunter's Specialties of Cedar Rapids, Iowa.

Grunts are characterized in that they typically have a decreasing tapered end 12 with the smallest outside diameter of end 12 being located at the very end 25 of the end whereas the outside diameter increases along the longitudinal axis 46 away from end 25. Further, a variety of continuous grooves 24 (FIG. 2) surround end 12.

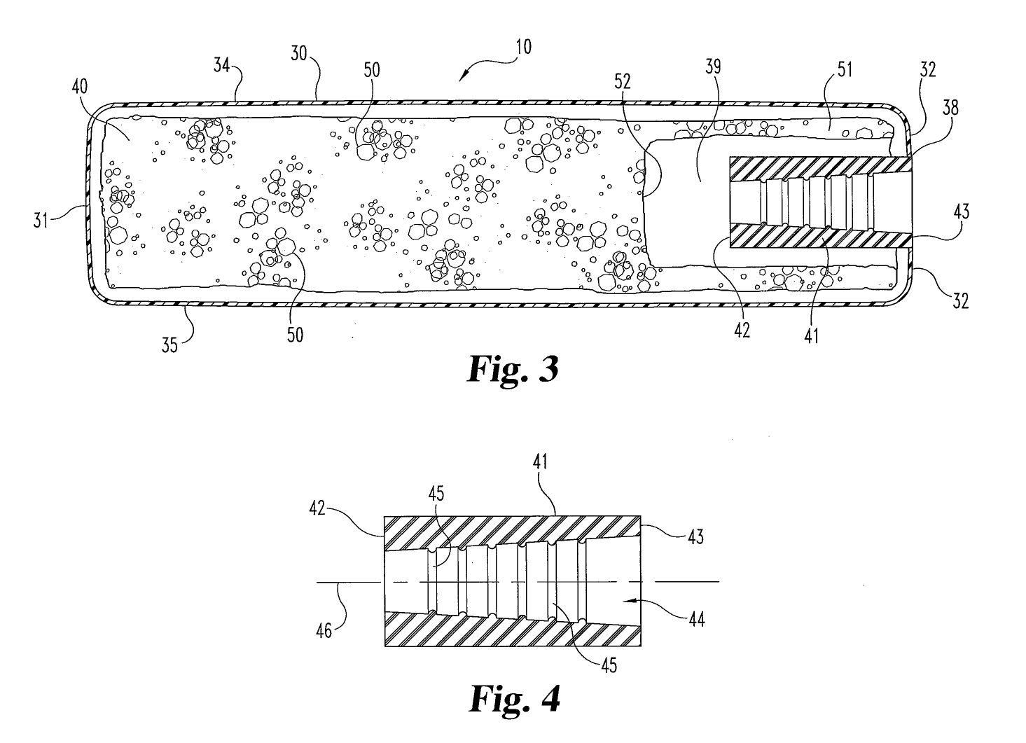

In order to provide for a squeezable portable container to force air into the grunt, I have devised an inlet to the squeezable container while making use of the tapered and grooved configuration of a typical grunt. Container 10 (FIGS. 1 and 3) includes a water impervious and flexible outer covering 30 configured as a six sided container having a pair of end walls 31 and 32 joined to a top wall 34 and bottom wall 35 with the end walls and top and bottom walls then further joined to a pair of side walls 36 and 37. Wall 32 includes a hole or air opening 38 leading to an air chamber 39. The air chamber is formed in a one piece filling 40 enclosed by all of the walls of covering 30.

Hollow sleeve 41 includes a first end 43 flush with wall 32 of covering 30 and an opposite end 42 extending into air chamber 39 formed by filling 40. Sleeve 41 is produced from rubber or other suitable flexible and stretchable material to accommodate the inlet tube of an animal call that is removably inserted into passage 44 (FIG. 4) extending through the sleeve from end 42 to end 43. Sleeve 41 has a constant outside diameter but a decreasing inside diameter as passage 44 extends from end 43 to end 42 thereby allowing the inlet tube of the animal call to be wedged into the passage. A plurality of continuous and inwardly extending projections 45 extend around the longitudinal axis 46 of the sleeve with projections 45 being parallel to each other.

In order to mount animal call 11 (FIG. 2) to container 10, end 12 is inserted into passage 44 through end 43 of the sleeve towards end 42. Eventually, one of the inwardly extending continuous projections 45 will seat in continuous groove 24 (FIG. 2) of the animal call thereby releasably holding the animal call to the sleeve. End 12 of animal call 11 is wedge shaped thereby causing the rubber sleeve 41 to stretch and releasably hold the animal call to the sleeve. Projections 45 extend radially toward axis 46 with the cross-section of passage 44 being smaller at end 42 as compared to end 43.

The one piece filling 40 enclosed by covering 30 may be produced from a compressible foam material, such as, an open cell synthetic sponge. As shown in FIG. 3, filling 40 includes a plurality of open cells 50 forming cavities for storing air. End 51 of filling 40 is positioned near but is spaced apart from end wall 32 of covering 30 and includes a cavity forming air chamber 39 into which sleeve 41 projects. Filling 40 surrounds the outside diameter of sleeve 41 with the air chamber 39 having an outwardly projecting surface 52 facing end 42 of the sleeve but spaced apart therefrom. End 42 of the sleeve is spaced approximately one inch from surface 52.

Squeezing container 10 results in the squeezing of the flexible cover 30 and filling 40 thereby first causing the air within chamber 39 to rush outwardly from the container via passage 44 and into passage 14 (FIG. 2) of the animal call, in turn, causing the reed 17 to vibrate emitting the animal noise. Continued squeezing or compression of filling 40 causes the air within cavities 50 to flow outwardly first into chamber 39 and then outwardly through sleeve 41 and the animal call. Filling 40 is spaced a sufficient distance apart from walls 31, 32, 34-37 to allow the air being forced from cavities 50 to flow into air chamber 39 and then into the sleeve. Decompression of the sleeve and covering results in the air flowing back through the animal call, through sleeve 41, into air chamber 39 and eventually into cavities 50.

The combination 9 of the animal call 11 with container 10 provides a particularly useful animal calling device in that the combination can be placed on the ground and then stepped on with either top wall 34 or bottom wall 35 providing a stepping surface in order to force air from the container thereby minimizing any damage to the container or sleeve 41 which is flexible.

The container is portable and includes a closure flap 60 with one end 62 fixedly attached to wall 34 of the covering and an opposite end 61 that is releasably engageable with walls 34 and 32. End 61 may be swung downwardly adjacent wall 32 to cover air opening 38 when the animal call device is not inserted therein thereby keeping debris from entering sleeve 41. Conventional fastening devices such as a hook and loop fastener combinations 63 provided on walls 34 and 32 and end 61 allow end 61 to be releasably held respectively to wall 34 when the animal call extends into opening 38 and to wall 32 when the flap extends over opening 38 and the animal call does not extend into opening 38.

A second flap 70 has an end 71 fixedly secured to wall 35 and has a second end 72 releasably lockable with the top wall 34. Wall 34 and end 72 may have a hook and loop fastener combination to releasably hold end 72 to wall 34. Flap 70 is provided to store an animal call between flap 70 and wall 36 when the animal call device is not in use and it is desired to store the animal call to the container.

Many variations are contemplated and included in the present invention. For example, the drawings show five inwardly extending projections 45. The inside diameters of the ridges or projections 45 decrease as the ridges are positioned around the axis in a direction from the outer end 43 to the inner end 42. It is to be understood that a number less than or greater than five projections 45 may be utilized to releasably lock the sleeve to the animal grunt.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A portable squeezable device for emitting a stream of air for causing a noise maker having an air inlet tube connectable to the device to emit noise comprising:
a closed container constructed to be squeezable and having an internal space with an air opening leading from said space to external of said container;
a one piece filling located within said internal space capable of holding air; and,
a hollow sleeve mounted in said opening having a first open end located within said space and a second open end opening externally from said container allowing internal air located within said space to be expelled through said sleeve and then into a noise maker connectable to said sleeve when said container and one piece filling are squeezed and external air to enter said space when said container and one piece filling are released.

2. The device of claim 1 wherein:
said sleeve defines an air passage with a longitudinal axis that extends from said first end to said second end, said air passage tapers having a smaller cross-sectional area near said first end within said space as compared to a larger cross-sectional area at said second end.

3. The device of claim 2 wherein:
said sleeve is flexible and stretchable to releasably hold the air inlet tube of a noise maker forcibly inserted therein:

4. The device of claim 3 wherein:
said sleeve has an air passage extending therethrough and a plurality of radially extending ridges located in said air passage that extend around said axis to frictionally engage the air inlet tube of a noise maker forcibly inserted therein.

5. The device of claim 1 wherein:
said filling is a compressible foam material.

6. The device of claim 5 wherein:
said foam material is a synthetic sponge material including a plurality of air holes formed therein normally holding air until said container and filling are squeezed causing air with said air holes to flow out through said sleeve into said noise maker with said air holes receiving air when said container and material are released causing air to flow back through said sleeve into said internal space.

7. The device of claim 1 wherein said noise maker is a grunt for producing an animal sound when said container and filling are squeezed causing air to flow into said grunt.

8. The device of claim 1 and further comprising:
a closure flap movably mounted to said container and having a first position extending across said air opening when said noise maker is not mounted to said container limiting debris from entering said space and a second position located apart from said air opening allowing the air inlet tube of the noise maker to be inserted into said sleeve.

9. The device of claim 8 wherein said second open end of said sleeve is flush with said container and said first open end is spaced apart approximately one inch from said filling forming an air chamber.

10. The device of claim 9 wherein:
said container includes a stepping surface, said sleeve and container are flexible allowing said stepping surface to be stepped on to force air therefrom minimizing any damage to said container or said sleeve.

11. An animal call for making an animal noise comprising:
a grunt having a hollow main body with a plurality of outwardly extending projections and forming a passage extending therethrough, said grunt further having an air inlet and a noise maker for producing an animal noise when air flows into said air inlet and then through said passage to said noise maker;
a flexible container having an internal cavity to hold air and an air opening leading form said internal cavity to external of said container;
a flexible insert positioned within said container and including a plurality of air cavities formed therein, said insert is smaller than said internal cavity forming an air chamber between said insert and said container; and,
a tube having a first end portion mounted to said container and extending via said air inlet into said air chamber and further having a second end slidably receiving said main body, said tube and main body having a matable projection and recess to releasably hold said grunt to said flexible container.

12. The animal call of claim 11 and further comprising:
a flap mounted to said container and movable to close said air opening when said tube is removed from said container to keep debris from entering said internal cavity.

13. The animal call of claim 11 and further comprising:
a grunt flap mounted to said container to hold a grunt against said container when not mounted to said tube.

14. The animal call of claim 13 wherein:
said container and insert are squeezable to first force air within said air chamber into said tube and then air within said air cavities into said tube.

15. A portable squeezable device having a universal connection for connecting to animal grunts for emitting a stream of air into an animal grunt having an air inlet tube to emit an animal noise comprising:
a squeezable container forming an internal cavity with an air opening leading to external of the container:
a squeezable filling located in said cavity and forming an air chamber adjacent said air opening; and,
a sleeve mounted to said squeezable container and extending through said air opening into said air chamber, said sleeve having an inner end and an outer end with an internal passage extending therebetween, said internal passage having a decreasing tapered size as it extends inwardly from said outer end, said passage including a plurality of inwardly extending projections to releasably hold an air inlet tube of an animal grunt.

16. The device of claim 15 wherein said internal passage has a longitudinal axis, said inwardly extending projections include a plurality of continuous ridges with inside diameters extending around said longitudinal axis, said inside diameters for said ridges decreasing in diameter as said ridges are positioned around said axis in a direction from said outer end to said inner end.

17. The device of claim 16 wherein there are five of said ridges integrally formed on said sleeve.

18. The device of claim 17 wherein said filling is spaced apart from said container at said air opening forming said air chamber into which said sleeve projects.

19. The device of claim 18 wherein said filling is a synthetic sponge material including a plurality of air cavities providing air storage space in addition to said air chamber allowing air within said air chamber to first be expelled from said container as said container is squeezed and then air in said cavity to flow outwardly.
